(19) United States
(12) Patent Application Publication
(10) Pub. No.: US 2026/0103849 A1
(43) Pub. Date: Apr. 16, 2026

(54) MOULD PART AND MOULDING STATION

(71) Applicant: Pulpex Limited, Sawston (GB)

(72) Inventor: Adam Richard TURNER, Croydon (GB)

(21) Appl. No.: 19/419,856

(22) Filed: Dec. 15, 2025

Related U.S. Application Data
(63) Continuation of application No. PCT/GB2024/051611, filed on Jun. 25, 2024.

(30) Foreign Application Priority Data
Jun. 29, 2023 (GB) 2309881.7

(51) Int. Cl. D21J 3/10

(52) U.S. Cl. CPC D21J 3/10

(57) ABSTRACT

Disclosed is a mould part for use in moulding a hollow moulded fibre product, the mould part co-operable in use with a further mould part to together define a cavity in which the hollow moulded fibre product is moulded, the mould part having a base portion corresponding to a part of a base of the hollow moulded fibre product to be moulded by the mould part in use, wherein the base portion has a positive draft angle. Also disclosed is a moulding station and a moulding system.

### CROSS-REFERENCE TO RELATED APPLICATIONS

This application is a continuation under 35 U.S.C. § 120 of International Application No. PCT/GB2024/051611, filed June 25, 2024, which claims priority to United Kingdom Application No. GB 2309881.7, filed June 29, 2023, under 35 U.S.C. § 119(a). Each of the above-referenced patent applications is incorporated by reference in its entirety.

### TECHNICAL FIELD

The present invention relates to mould parts, moulds, moulding stations, moulding systems and methods used in manufacturing receptacles from a fibre suspension, such as a fibre suspension comprising paper pulp. The receptacles may be consumer packaging, such as bottles, jars or certain types of vases, useful for holding liquids, powders, other flowable materials, one or more solid objects, or a combination thereof.

### BACKGROUND

It is desirable to reduce glass and plastics use in consumable items, particularly packaging. Non-necked receptacles, such as trays, bowls and other simple shapes, are commonly made from paper pulp. However, a more complex necked receptacle, like a bottle, jar or certain types of vase, is more difficult to engineer due to an internal narrowing of the receptacle between a main body portion of the receptacle and an opening of the receptacle.

At certain stages, particularly early stages, during formation of a hollow moulded fibre product, the hollow moulded fibre product may be relatively fragile. The hollow moulded fibre product may thus be easily damaged by impact, for example during handling of the hollow moulded fibre product.

### SUMMARY

According to a first aspect of the present invention, there is provided a mould part for use in moulding a hollow moulded fibre product, the mould part being co-operable in use with a further mould part to together define a cavity in which the hollow moulded fibre product is moulded, the mould part having a base portion corresponding to a part of a base of the hollow moulded fibre product to be moulded by the mould part in use, wherein the base portion has a positive draft angle.

At certain stages, particularly early stages, during formation of a hollow moulded fibre product, the hollow moulded fibre product may be relatively fragile. The hollow moulded fibre product may thus be easily damaged by impact, for example during handling of the hollow moulded fibre product. The base portion is non-parallel to a direction of demoulding from the mould part, which may reduce a force required to remove the hollow moulded fibre product from the mould part compared to the base portion being parallel to the direction of demoulding or the base portion having a negative draft angle. In turn, this provides the advantage of helping to reduce the chance of damage to the hollow moulded fibre product as the hollow moulded fibre product is removed, or demoulded, from the mould part after moulding in the mould part. The positive draft angle may also assist with subsequently inserting the hollow moulded fibre product into another mould.

During moulding of a hollow moulded fibre product and subsequent demoulding of the hollow moulded fibre product, stray fibres can be caused to extend from an outer surface of the hollow moulded fibre product. Such stray fibres can become trapped between the mould parts of a subsequent mould, for example a thermoforming mould, and can damage contacting surfaces of the mould parts of the subsequent mould. Providing a mould part with a base portion having a positive draft angle provides a hollow moulded fibre product with a generally convex base. Accordingly, a smaller portion of the base of the hollow moulded fibre product may contact a mould part of the subsequent mould, as the hollow moulded fibre product is inserted into the mould part of the subsequent mould, compared with a hollow moulded fibre product moulded in a mould part having a flat base portion. This may reduce the number of stray fibres that may become trapped between the mould parts of the subsequent mould.

In some examples, all of the base portion has either a positive draft angle, or a combination of a positive draft angle and a neutral draft angle. That is, no part of the base portion has a negative draft angle.

The mould part comprises an aperture through which the hollow moulded fibre product is passed during demoulding of the hollow moulded fibre product from the mould part. The aperture extends along a split plane of the mould part. A demoulding direction of the mould part is orthogonal to the split plane. The base portion is non-orthogonal to the split plane of the mould part, and is at an acute angle relative to the split plane. Thus, the base portion is at a positive draft angle relative to the demoulding direction.

In some examples, the positive draft angle does not exceed 5 degrees. At greater angles, the hollow moulded fibre product may be more likely to be damaged during subsequent processing in which a shape of a base of the hollow moulded fibre product is altered, for example processing in which a punt is formed in the base of the hollow moulded fibre product or the base of the hollow moulded fibre product is flattened. At positive draft angles not exceeding 5 degrees, the benefit of easier demoulding from the mould part is provided, without formation of a sharp vertex (i.e., less than 170 degrees) along a split line of the base of the hollow moulded fibre product in use of a mould comprising the mould part. A sharp vertex along a split line of the base of the hollow moulded fibre product may represent an area more prone to damage during processing of the hollow moulded fibre product.

In some examples, the positive draft angle does not exceed 4.5 degrees, 4 degrees, 3.5 degrees, or 3 degrees.

In some examples, the positive draft angle is uniform across the base portion. That is, the base portion is planar. This may further aid demoulding of the hollow moulded fibre product from the mould part compared with demoulding from a mould part comprising a non-planar base portion.

In some examples, a free edge of the base portion extends linearly along a split plane of the mould part in a direction normal to a longitudinal axis of the mould part. The longitudinal axis of the mould part extends along the split plane from a centre of the base portion towards an upper portion of the mould part.

In some examples, the free edge of the base portion is a lowermost edge of an internal moulding cavity partially defined by the mould part.

In some examples, the base portion comprises one or more dewatering apertures extending therethrough. In use of the mould part, water (optionally containing additives) from a fibre slurry is drawn through the one or more dewatering apertures. Such a process may be referred to as dewatering.

In some examples, each of the one or more dewatering apertures defines a respective conduit fluidly connecting an internal moulding cavity partially defined by the mould part to an outside of the mould part, the conduits being obliquely angled relative to a demoulding direction of the mould part. During dewatering, fibres from the fibre slurry may be drawn, at least partially, into the one or more dewatering apertures and may subsequently inhibit demoulding of the hollow moulded fibre product from the internal moulding cavity partially defined by the mould part due to additional force being required to release the stray fibres from the dewatering apertures. With the conduits obliquely angled to the demoulding direction of the mould part, a force required to remove the hollow moulded fibre product from the mould part may be less than a mould part in which the dewatering apertures extend in a direction normal to the demoulding direction.

In some examples, the demoulding direction is normal to the split plane.

In some examples, the conduits extend in a direction normal to the base portion. Since the base portion has a positive draft angle, the dewatering apertures thus extend in a direction that is non-parallel to a split plane of the mould split, and non-normal to the demoulding direction of the mould part. Accordingly, a force required to remove the hollow moulded fibre product from the mould part may be less than a mould part in which the dewatering apertures extend in a direction parallel to the part plane of the mould part. This is because the stray fibres are less likely to extend into the conduits at an angle that is normal to the demoulding direction of the hollow moulded fibre product from the mould part.

In some examples, the mould part comprises one or more side walls upstanding from the base portion, wherein a height of the one or more side walls at a split plane of the mould part is greater than a height of the one or more side walls at a rear of the mould part, opposite the split plane. This may allow the positive draft angle on the base portion. This may also give the hollow moulded fibre product a height differential, which may reduce a chance of part of a base of the hollow moulded fibre product catching on a rim of a mould part of a subsequent mould, for example a thermoforming mould.

In some examples, at the split plane, the side walls extend perpendicularly away from the split plane. This may help to mould a hollow moulded fibre product with smooth walls at the split plane, and to aid demoulding of the hollow moulded fibre product from the mould part.

In some examples, the mould part comprises a single side wall having a semi-circular cross-sectional profile, as viewed from an end, i.e., a top or bottom, of the mould part. This may further help with demoulding the hollow moulded fibre product from the mould part.

According to a second aspect of the present invention, there is provided a moulding station for use in moulding a hollow moulded fibre product, the moulding station comprising a mould having a first mould part and a second mould part, each of the first and second mould parts being according to the first aspect, wherein the first and second mould parts are co-operable with each other, in use of the mould, to together define a mould cavity, in which the hollow moulded fibre product is moulded. Such a moulding station may provide the advantages described above with reference to the first aspect.

In some examples, the base portion of the first mould part and the base portion of the second mould part have the same positive draft angle. This may help to ensure that the mould cavity has a substantially symmetrical base, formed of the base portions of the first and second mould parts. Accordingly, a base of the hollow moulded fibre product may be substantially symmetrical about a split plane of the mould.

In some examples, the cavity defined by the first and second mould parts is symmetrical about the split plane.

According to a third aspect of the present invention, there is provided a moulding system for providing a thermoformed hollow moulded fibre product, the moulding system comprising: a moulding station of the second aspect; and a thermoforming mould,

wherein the thermoforming mould comprises a third mould part and a fourth mould part co-operable, in use of the thermoforming mould, to together define a thermoforming cavity in which the hollow moulded fibre product is moulded to form the thermoformed hollow moulded fibre product, each of the third and fourth mould parts comprising a respective base portion having a draft angle that is less than the positive draft angle of the base portion of the first mould part and the base portion of the second mould part.

During use of the thermoforming mould, the third and fourth mould parts of the thermoforming mould are held, or clamped, shut with a relatively large pressure, compared with moulds used for forming thermoformed non-hollow moulded fibre products, such that fibres trapped between the third and fourth mould parts can damage contacting surfaces of the mould parts.

By using the mould to form the hollow moulded fibre product, the hollow moulded fibre product is formed with a base that is more convex than the corresponding base portions of the thermoforming mould. Accordingly, only a small portion of the base of the hollow moulded fibre product may contact the respective base portions of the third and fourth mould parts as the hollow moulded fibre product is inserted into the thermoforming mould. In turn, this may reduce a chance of damage being caused to the base of the hollow moulded fibre product during insertion into the thermoforming mould and/or lessen the accumulation of fibres at a rim of the third or fourth mould part during insertion of the hollow moulded fibre product into the third or fourth mould part of the thermoforming mould.

In some examples, each of the base portions of the third and fourth mould parts has a draft angle of zero degrees, which provides a thermoformed hollow moulded fibre product with a flat base. In some examples, each of the base portions of the third and fourth mould parts has a negative draft angle, and may provide a punt in the base of the thermoformed hollow moulded fibre product.

In some examples, a bottom edge of sidewalls of the third and fourth mould parts defines a lowermost edge of respective internal moulding cavities defined by the third and fourth mould parts.

In some examples, the third and fourth mould parts are configured to be held together with a pressure of at least 15 bar. This may help to overcome pressure exerted against internal surfaces of the thermoforming mould by a bladder inserted within the hollow moulded fibre product during use of the thermoforming mould, when such a bladder is used.

In some examples, the third and fourth mould parts are configured to be held together with a pressure of at least 20 bar.

In some examples, the moulding system comprises a transfer mechanism for transferring the hollow moulded fibre product from the moulding station to the thermoforming mould.

According to a fourth aspect of the present invention, there is provided a method of providing a hollow moulded fibre product using a mould comprising a first mould part and a second mould part, the first and second mould parts being co-operable with each other, in use of the mould, to together define a mould cavity and each having a base portion with a positive draft angle, the method comprising: supplying a fibre slurry to the mould cavity; and moulding, using the mould, the fibre slurry in the mould cavity to provide the hollow moulded fibre product, the hollow moulded fibre product having a convex base as a result of the draft angles of the base portions of the first and second mould parts.

Such a method may provide the advantages described above with reference to the first aspect. Each of the first and second mould parts may be according to the first aspect. The mould may be comprised in the moulding station of the second aspect or the moulding system of the third aspect.

In some examples, the method comprises demoulding the hollow moulded fibre product from the mould. The positive draft angle in the base portion of each of the first and second mould parts may aid such demoulding.

According to a fifth aspect of the present invention, there is provided a method of providing a thermoformed hollow moulded fibre product, the method comprising performing a method of the fourth aspect; subsequently transferring the hollow moulded fibre product to a thermoforming mould, the thermoforming mould comprising a third mould part and a fourth mould part co-operable, in use of the thermoforming mould, to together define a thermoforming cavity, each of the third and fourth mould parts comprising a respective base portion having a draft angle that is less than the positive draft angle of the base portion of the first mould part and the positive draft angle of the base portion of the second mould part; closing the third and fourth mould parts when the hollow moulded fibre product is in the thermoforming cavity; and thermoforming, using the thermoforming mould, the hollow moulded fibre product in the thermoforming cavity to provide the thermoformed hollow moulded fibre product.

Such a method may provide the advantages described above with reference to the third aspect. The thermoforming mould may be according to the third aspect. The method may be performed by the moulding system of the third aspect.

In some examples, the thermoformed hollow moulded fibre product has a flat base. In some examples, the thermoformed hollow moulded fibre product has a concave base, for example has a punt.

In some examples, the thermoformed hollow moulded fibre product has a less convex base than the hollow moulded fibre product.

According to a sixth aspect of the present invention, there is provided a moulding system controller configured to cause a moulding station for use in moulding a hollow moulded fibre product to perform a method of the fourth aspect, or to cause a moulding system for providing a thermoformed hollow moulded fibre product to perform a method of the fifth aspect.

According to a seventh aspect of the present invention, there is provided a non-transitory storage medium storing machine-readable instructions that, when executed by a processor of a moulding system controller, cause the processor to cause a moulding station to perform a method of the fourth aspect, or cause the processor to cause a moulding system to perform a method of the fifth aspect.

In some examples of any of the above aspects, the hollow moulded fibre product is a necked hollow moulded fibre product, such as a bottle, a jar or a type of vase. In some examples of any of the above aspects, the hollow moulded fibre product is a bottle.

According to an eighth aspect of the present invention, there is provided a receptacle manufacturing line comprising a moulding system of the third aspect for providing the thermoformed hollow moulded fibre product and apparatus for performing at least one additional process on the thermoformed hollow moulded fibre product to provide the receptacle.

The apparatus may comprise an interior coater and the at least one additional process may comprise the interior coater coating at least a portion of an interior of the product to produce an internally coated product. The apparatus may comprise a closure-part applicator and the at least one additional process may comprise the closure-part applicator applying a closure part to the product or the internally coated product to produce a closable or closed product. The apparatus may comprise an exterior coater and the at least one additional process may comprise the exterior coater coating at least a portion of an exterior of the product or the internally coated product or the closable or closed product to produce an externally coated product. The apparatus may comprise a decorator and the at least one additional process may comprise the decorator decorating the product or the internally coated product or the closable or closed product or the externally coated product to produce a decorated product. The apparatus may comprise a dryer and the at least one additional process may comprise the dryer drying the product or the internally coated product or the closable or closed product or the externally coated product or the decorated product to produce a dried product. The apparatus may comprise an evaluator and the at least one additional process may comprise the evaluator evaluating the product, the internally coated product, the closable or closed product, the externally coated product, the decorated product, or the dried product to produce an evaluated product. In some examples, the receptacle is the product, the internally coated product, the closable or closed product, the externally coated product, the decorated product, the dried product, or the evaluated product.

In some examples, the receptacle is a necked receptacle, such as a bottle, jar or a type of vase, and the receptacle manufacturing line is a necked-receptacle manufacturing line. In some examples, the receptacle is a bottle.

According to a ninth aspect of the present invention, there is provided a method of manufacturing a receptacle, the method comprising performing a method of the fifth aspect to provide the thermoformed hollow moulded fibre product, and then performing at least one additional process on the thermoformed hollow moulded fibre product to provide the receptacle.

The at least one additional process may comprise coating at least a portion of an interior of the product to produce an internally coated product. The at least one additional process may comprise applying a closure part to the product or the internally coated product to produce a closable or closed product. The at least one additional process may comprise coating at least a portion of an exterior of the product or the internally coated product or the closable or closed product to produce an externally coated product. The at least one additional process may comprise decorating the product or the internally coated product or the closable or closed product or the externally coated product to produce a decorated product. The at least one additional process may comprise drying the product or the internally coated product or the closable or closed product or the externally coated product or the decorated product to produce a dried product. The at least one additional process may comprise evaluating the product, the internally coated product, the closable or closed product, the externally coated product, the decorated product, or the dried product to produce an evaluated product. In some examples, the receptacle is the product, the internally coated product, the closable or closed product, the externally coated product, the decorated product, the dried product, or the evaluated product.

In some examples, the receptacle is a necked receptacle, such as a bottle, jar or a type of vase. In some examples, the receptacle is a bottle.

According to a tenth aspect of the present invention, there is provided a method of providing a content-containing receptacle, the method comprising providing a receptacle obtained by a method of the ninth aspect and providing contents in the receptacle to provide the content-containing receptacle.

In some examples, the providing contents in the receptacle comprises putting the contents into the receptacle. In contrast, in some examples, the providing the receptacle comprises providing the receptacle with the contents already present in the receptacle, thereby providing contents in the receptacle.

The contents may be in the form of, for example, a liquid, a powder, other flowable materials, one or more solid objects, or a combination thereof. For example, the contents may be a foodstuff such as a condiment, a beverage such as an alcoholic beverage, a household care product such as a detergent or other cleaning product, a personal care product such as a hair care product or a personal cleansing product or a healthcare product or a pharmaceutical product or a cosmetics product, a fragrance product such as a perfume, a vehicle product such as motor oil, or an industrial product. Other suitable contents will be apparent to the skilled reader in view of the content of this application and their common general knowledge.

In some examples, the receptacle is a necked receptacle, such as a bottle, a jar or a type of vase. In some examples, the receptacle is a bottle.

In some examples, the method comprises: closing an opening of the receptacle after the providing contents in the receptacle, and/or applying a label or indicia to the receptacle.

In some examples, the closing comprises applying a closure (such as a lid or a cap or a heat seal) to the receptacle to close the opening. In some examples, the closing comprises applying a heat seal to the receptacle and (e.g., thereafter) applying a lid or a cap to the receptacle.

In some examples, the applying the label or indicia to the receptacle occurs after the providing the contents in the receptacle (that is, the label or indicia is applied to the content-containing receptacle). In other examples, the applying the label or indicia to the receptacle occurs before or during the providing the contents in the receptacle.

In some examples, the applying occurs before the closing. In some examples, the applying occurs after the closing. In some examples, the applying occurs during the closing.

According to an eleventh aspect of the present invention, there is provided use of a receptacle obtained by a method of the ninth aspect to contain contents. The use could be, for example, by a person (such as a natural person or a company) who puts the contents into the receptacle, or by a person who transports the contents, or by a person who wishes to dispose of (e.g., to a consumer or end user), offer to dispose of (e.g., to a consumer or end user), import, or keep the contents whether for disposal or otherwise.

The contents may, for example, be in the form of any of those discussed above.

In some examples, the receptacle is a necked receptacle, such as a bottle, a jar or a type of vase. In some examples, the receptacle is a bottle.

According to a twelfth aspect of the present invention, there is provided a receptacle obtainable or obtained from a fabrication method comprising the method of any one of the fifth, ninth or tenth aspects.

For example, the receptacle may be obtainable or obtained from the method of the second aspect of the present invention. The fabrication method may comprise at least one additional process. The at least one additional process may comprise coating at least a portion of an interior of the product to produce an internally coated product. The at least one additional process may comprise applying a closure part to the product or the internally coated product to produce a closable or closed product. The at least one additional process may comprise coating at least a portion of an exterior of the product or the internally coated product or the closable or closed product to produce an externally coated product. The at least one additional process may comprise decorating the product or the internally coated product or the closable or closed product or the externally coated product to produce a decorated product. The at least one additional process may comprise drying the product or the internally coated product or the closable or closed product or the externally coated product or the decorated product to produce a dried product. The at least one additional process may comprise evaluating the product, the internally coated product, the closable or closed product, the externally coated product, the decorated product, or the dried product to produce an evaluated product. In some examples, the receptacle is the product, the internally coated product, the closable or closed product, the externally coated product, the decorated product, the dried product, or the evaluated product.

In some examples, the receptacle is a necked receptacle, such as a bottle, jar or a type of vase. In some examples, the receptacle is a bottle.

Receptacles obtainable or obtained from such a fabrication method may be discernible from receptacles made by other methods; such receptables may comprise features indicative of the change in shape of the base portion of the hollow moulded fibre product precursor that took place to thereby provide the hollow moulded fibre product from the hollow moulded fibre product precursor. Indicative features may comprise, for example, fibres that are aligned in a direction in which the base portion of the hollow moulded fibre product precursor was re-shaped, and/or fibres that are teased away from one another in the direction in which the base portion of the hollow moulded fibre product precursor was re-shaped, albeit to a degree that is acceptable given the intended function of the end product.

It will be appreciated that optional features of aspects of the present invention may be equally applied to other aspects of the present invention, where appropriate.

### BRIEF DESCRIPTION OF DRAWINGS

Embodiments of the invention will now be described, by way of example only, with reference to the accompanying drawings, in which:

FIG. 1 is a schematic view of an example receptacle manufacturing line for performing a method of manufacturing receptacles from paper pulp;

FIG. 2 is a schematic view of a moulding system according to an example;

FIG. 3 is a cross-sectional view of a mould according to an example;

FIGS. 4a and 4b are views of a mould part of the mould of FIG. 3;

FIG. 5 is a cross-sectional view of part of a mould part of the mould of FIG. 3;

FIG. 6 is a cross-sectional view of part of a thermoforming mould, in use, according to an example;

FIGS. 7a and 7b show a receptacle at various stages of manufacture, according to an example;

FIG. 8 shows a method according to an example;

FIG. 9 shows a method according to an example;

FIG. 10 shows a non-transitory computer-readable storage medium according to an example;

FIG. 11 shows a schematic cross-sectional view of a receptacle containing contents, according to an example; and

FIG. 12 shows a method of providing a content-containing receptacle.

### DETAILED DESCRIPTION

The following description presents exemplary embodiments and, together with the drawings, serves to explain principles of embodiments of the invention.

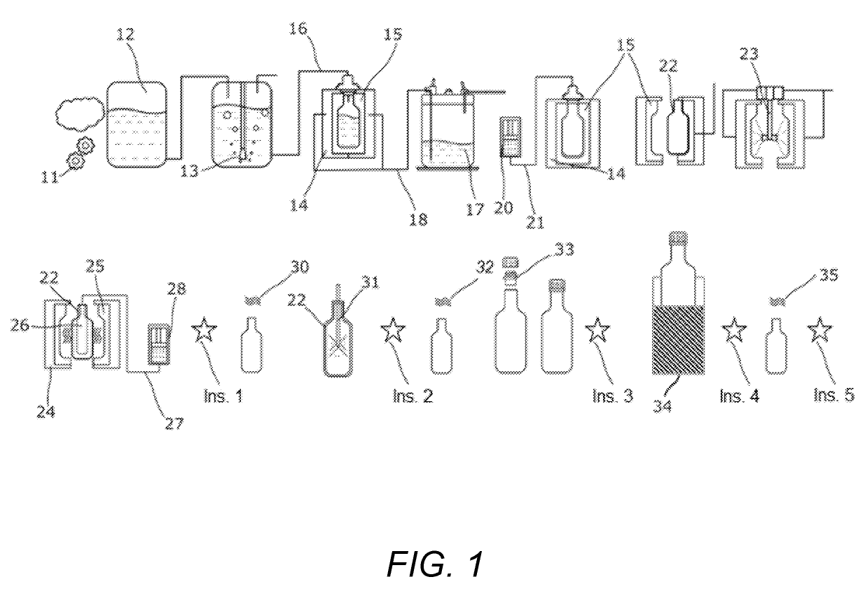

FIG. 1 shows a receptacle manufacturing line for performing a method of manufacturing receptacles, in this case necked receptacles, and more specifically in this case in the form of bottles, from paper pulp (i.e., which can form the basis of an example fibre suspension). By “necked receptacle” it is meant that the receptacle has an internal narrowing, or “neck”, between a main body portion, in which most of or all the contents of the receptacle are stored in use, and an opening through which the contents can enter or leave the receptacle in use. The internal width of the receptacle at the neck may be the same as or different to the internal width of the opening. However, the internal width of the neck is smaller than that of the main body portion, so that a shoulder is defined by and between the neck and the main body portion. This shoulder complicates manufacture of the receptacle, since it interferes with subsequent removal (and, in some cases, insertion) of whatever mould tool is inserted into the receptacle to form the internal shape of the receptacle. Examples of necked receptacles are bottles, jars, and certain types of vases. The process is merely exemplary and is provided to give context to examples of the present invention. It will be appreciated that, in other examples, the receptacle manufacturing line could be for making non-necked receptacles (i.e., receptacles without such a neck), such as bowls or trays.

Broadly speaking, the exemplary process comprises providing a fibre suspension, introducing the fibre suspension into a mould cavity of a porous first mould and expelling a liquid (such as water) from the fibre suspension to produce a hollow moulded fibre product (which may be called a wet precursor or embryo) in the mould cavity, further moulding the hollow moulded fibre product to produce a hollow further-moulded fibre product, drying and then internally-coating the hollow further-moulded fibre product to produce an internally coated product, drying the internally coated product to produce a dried product, applying a closure part to the dried product to produce a closable or closed product, externally-coating and/or decorating the closable or closed product to produce an externally coated and/or decorated product, and then drying the externally coated or decorated product to produce another dried product. As will be apparent at least from the following description, modifications may be made to the exemplary process to provide variants thereof in which other examples of the present invention may be embodied. For example, in some cases, either the internal coating or the external coating and/or decorating may be omitted. Moreover, in the present case and as indicated by the stars labelled Ins. 1 to Ins. 5 in FIG. 1, the process comprises inspecting or evaluating the hollow further-moulded fibre product, the internally coated product, the closable or closed product, the externally coated or decorated product, and the dried product to produce respective evaluated products. In some examples, the receptacle is the hollow moulded fibre product, the hollow further-moulded fibre product, the internally coated product, the closable or closed product, the externally coated or decorated product, one of the dried products, or one of the respective evaluated products.

In this example, providing the fibre suspension comprises preparing the fibre suspension from ingredients thereof. More specifically, the preparing comprises providing pulp fibres, such as paper pulp fibres, and mixing the pulp fibres with a liquid to provide hydrated pulp fibres. In this example, the pulp fibres are provided in sheet form from a supplier and the liquid comprises water and one or more additives. In this example, the liquid is mixed with the pulp fibres to provide hydrated pulp fibres having a solid fibres content of 1wt% to 5wt% (by dry mass of fibres). In examples, the one or more additives includes a sizing agent, such as alkylketene dimer (AKD). The hydrated pulp fibres typically comprise AKD in an amount of 0.4wt% with respect to the total dry mass of the solid fibres in the hydrated pulp fibres. In some examples, one or more additives are present in the liquid at the point of mixing the pulp fibres with the liquid. In some examples, one or more additives are included in the hydrated pulp fibres after mixing the pulp fibres with the liquid (for example, the pulp fibres are hydrated for a period of time, such as from 2 to 16 hours, and then one or more additives are supplied to the hydrated pulp fibres). The hydrated pulp fibres are passed between plates of a valley beater 11 or refiner that are in motion relative to each other. This fibrillates some, or all, of the fibres, meaning that cell walls of those fibres are caused to become partially delaminated so that wetted surfaces of those fibres comprise protruding hairs or fibrillations. These fibrillations will help to increase a strength of bonds between the fibres in the dried end product. In other examples, the valley beater 11 or refiner may be omitted.

The resultant processed pulp is stored in a vat 12 in a relatively concentrated form (for example, a solid fibres content of 1wt% to 5wt%) to reduce a required storage space. At an appropriate time, the processed pulp is transferred to a mixing station 13 at which the processed pulp is diluted in further water and, optionally, mixed with one or more additives (as well as, or in place of, the one or more additives provided with the hydrated pulp fibres) to provide the fibre suspension ready for moulding. In this example, the solid fibres account for 0.7wt% of the resultant fibre suspension (by dry weight of fibres), but in other examples the proportion of solid fibres in the fibre suspension may be different, such as another value in the range of 0.5wt% to 5wt%, or 0.1wt% to 1wt%, of the fibre suspension (by dry weight of fibres). In some examples, the one or more additives mixed with the processed pulp and water includes a dewatering agent, such as modified and/or unmodified polyethylene imine (PEI), for example modified PEI sold under the trade name Polymin® SK. In some examples, the one or more additives are mixed with the water, and the water and one or more additives subsequently mixed with the processed pulp; in other examples, the processed pulp and water are mixed, and the one or more additives subsequently mixed with the processed pulp and water. The fibre suspension typically comprises Polymin® SK in an amount of 0.3wt% with respect to the total dry mass of the solid fibres. Mixing of the fibre suspension at the mixing station 13 helps to homogenise the fibre suspension. In other examples, the processed pulp or the fibre suspension may be provided in other ways, such as being supplied ready-made.

Downstream of the vat 12 and the mixing station 13 is a first moulding station that comprises a porous first mould 15. In this example, the porous first mould 15 comprises two half-moulds 14 that are movable towards and away from each other, in this case using a hydraulic ram. In this example, each of the half-moulds 14 is a monolithic or unitary tool formed by additive manufacturing (for example, 3D-printing) that defines a mould profile, and, when the half-moulds 14 are brought into contact with each other, their respective mould profiles cooperate to define the mould cavity in which the hollow moulded fibre product is to be formed. Each half-mould 14 itself defines a smaller moulding cavity and, when brought into cooperation with a second half-mould 14, the smaller moulding cavities combine to provide the overall mould cavity. The two half-moulds 14 may themselves be considered “parts”, “splits” or “moulds” and the overall porous first mould 15 may be considered a “split-mould” or, again, a “mould”. In other examples, the porous first mould 15 may comprise more than two splits 14, such as three, four or six splits, that cooperate to define the moulding cavity.

In FIG. 1, the fibre suspension (also known as slurry) is top-filled into the porous first mould 15, in contrast to moulding processes that dip a mould in slurry. The fibre suspension is drawn under vacuum via a line 16 and into the porous first mould 15, with excess suspending liquid being drawn through the porous first mould 15 under vacuum via a line 18 into a tank 17. Shot mass may be controlled by measuring (for example, weighing) the amount of liquid drawn into the tank 17. A weight scale platform supporting the tank 17 is visible in FIG. 1. Once a required amount (for example, a predetermined volume, such as 10 litres, or a predetermined mass, such as 10 kilograms) of liquid has been collected in the tank 17, suction of the suspending liquid through the porous first mould 15 is stopped and the first mould 15 is opened to ambient air. In this example, the suspending liquid drawn with the fibre suspension in line 16 is water, or predominantly water (as additives may also be present). The liquid drawn under vacuum via the line 18 and into the tank 17 is substantially free of fibres, since these are left behind against the walls of the porous first mould 15 to form the hollow moulded fibre product.

In one example, in order to remove further suspending liquid (for example, water) from the hollow moulded fibre product, and form or consolidate the three-dimensional shape of the product, high pressure fluid (such as compressed air) is introduced into the first mould 15 to compress the fibre suspension against the cavity wall of the first mould 15. This process strengthens the product so that it can be handled, and displaces water from in between the fibres, thereby increasing the efficiency of a subsequent drying process. The fluid is regulated using a hydraulic pump 20. The pump 20 has a cylinder that displaces the fluid in a line 21 into the first mould 15. In an alternative example, an impermeable inflation element in the form of a collapsible bladder is inserted into the first mould 15 and expanded, by introduction of a fluid into the bladder from the line 21, to act as an internal high-pressure core structure for the first mould 15. In such an alternative, the fluid within the line 21 is preferably non-compressible, such as water or oil, although in other examples it could be a compressible fluid, such as air. Water has the advantage over other non-compressible liquids that any leaking or bursting of the bladder will not introduce a new substance to the system (since the suspending liquid is already water, or predominantly water).

Demoulding occurs when the first mould 15 opens for removal of the self-supporting hollow moulded fibre product 22. Mould cleaning 23 is preferably performed subsequently, to remove any remaining small fibres and/or other debris and maintain a porosity of the porous first mould 15. In this example, a radially firing high-pressure jet is inserted into the mould cavity while the first mould 15 is open. This dislodges debris from the wall of the mould cavity. Alternatively, or in addition, water from the tank 17 is pressurised through the back of the porous first mould 15 to dislodge entrapped fibres and/or other debris. Water is drained for recycling back to an upstream part of the system. It is noteworthy that cleaning is important for conditioning the first mould 15 for re-use. The first mould 15 may appear visibly clean after removal of the receptacle, but its performance could be compromised without cleaning.

According to FIG. 1, the hollow moulded fibre product 22 is subsequently transported to a second moulding station where, in a, for example, aluminium, mould 25, pressure and heat are applied for thermoforming a desired neck and surface finish, optionally including embossed and/or debossed surface features. After two halves of the mould 25 have closed around the product 22, a pressuriser is engaged. For example, a bladder 26 (for example, a thermoforming bladder 26) is inserted into the product 22. The bladder 26 is inflated with a pressurised fluid supplied via a line 27 by a pump 28. The pressurised fluid is preferably a non-compressible fluid such as water or oil, although in other examples it could be a compressible fluid such as air. In other examples, during supply, the pressurised fluid is heated with, for example, a heater or, alternatively, is cooled with, for example, a heat exchanger. An external mould block 24 of the mould 25, and/or the mould 25 itself, is also, or alternatively, heated in some examples. After thermoforming, a state of the product 22, which may now be considered a hollow further-moulded fibre product, is considerably more rigid, with more compressed side walls, as compared with the state of the product 22 at demoulding from the first mould 15.

A drying stage 30 (for example, a microwave drying process or other drying process) is performed on the product 22 downstream of the thermoforming, as shown, to provide a dried product. In one example, the drying stage 30 is performed before thermoforming to provide a dried product. However, moulding in the mould 25 requires some water content to assist with bonding during the compression process. The drying may be performed using a dryer, such as a machine that acts to cause drying of the product or simply a shelf or other support on which the product 22 rests while drying.

The product 22 is then subjected to an internal-coating stage during which, in this example, an interior coater in the form of a spray lance 31 is inserted into the product 22 and applies one or more surface coatings to internal walls of the product 22 to produce an internally coated product. In another example, the product 22 is instead filled with and subsequently drained of a liquid that coats the internal walls of the product 22. In practice, such coatings provide a protective layer to prevent egress of contents into the bottle wall, which may permeate and/or weaken it. Coatings will be selected dependent on the intended contents of finished receptacle, for example, a beverage, foodstuff, detergent, lubricant, pharmaceutical product, etc. In this example, the internally coated product 22 is then subjected to a curing or drying process 32, which can be configured or optimised dependent on the internal coating, for example, drying for twenty-four hours at ambient conditions or by a flash drying method. The drying again may be performed using a dryer, such as a machine that acts to cause drying of the product or simply a shelf or other support on which the product 22 rests while drying. Following the drying, the coated product 22 is considered another dried product.

A closure or mouth forming process is then performed on the product 22 by a closure-part applicator to produce a closable or closed product. For example, as shown in FIG. 1, a neck fitment 33 is affixed to the dried product. This results in the product being closable subsequently by positioning of a cap, lid or other closure relative to the neck fitment. An exterior coating and/or decoration is then applied to the product 22 by an exterior coater and/or a decorator, respectively, as shown in the further stage 34, to produce an externally coated and/or decorated product. In one example, the product 22 is dipped into a liquid to coat its outer surface, as shown in FIG. 1. In another example, the outer surface receives the external coating in a different manner. The coating and/or decoration may cover all or only part of an external surface of the product. The product 22 is then allowed to dry in warm air to produce another dried product. In other examples, the drying may be performed using a dryer such as one of those discussed above.

The product 22 may therefore be fully formed, considered the end “receptacle”, and ready to accept contents therein. In other examples, the receptacle may be fully formed without the neck fitment 35 being affixed and/or without the interior coating being applied and/or without the exterior coating being applied and/or without the decoration being applied and/or immediately after one of the drying processes or one of the inspecting and/or evaluating processes. For example, in some cases, the product is provided with the closure part by moulding the closure part during moulding of the product at the first moulding station and/or the second moulding station.

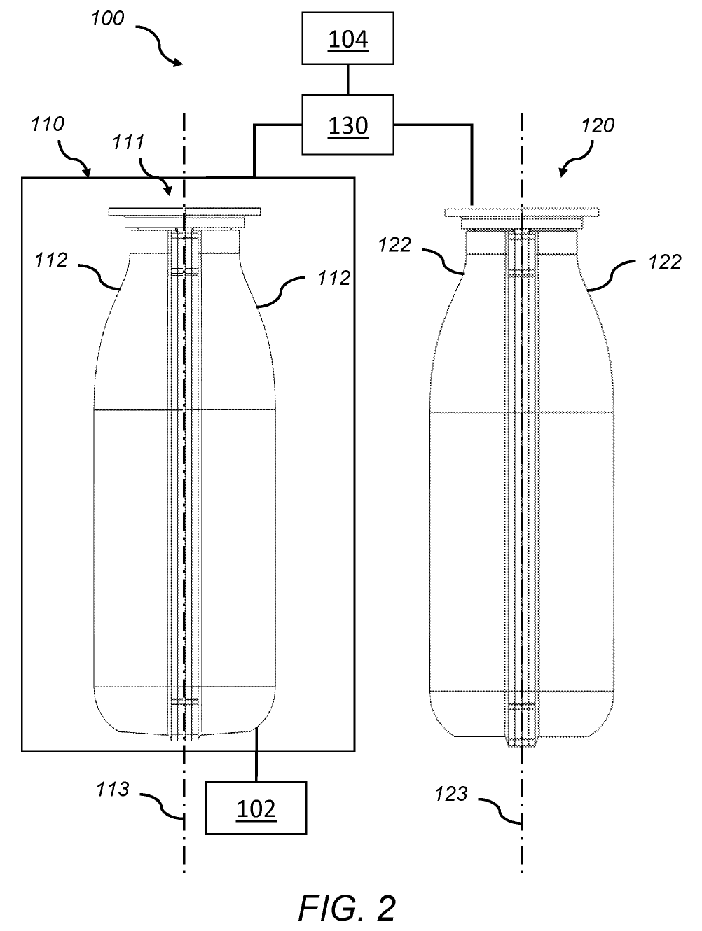

FIG. 2 shows a moulding system 100, according to an example, for providing a thermoformed hollow moulded fibre bottle 22b. The moulding system 100 comprises a moulding station 110, a thermoforming mould 120, and a transfer mechanism 130. The moulding station 110 comprises a mould 111 having a pair of mould parts 112 that are co-operable with each other along a split plane 113 to define a mould cavity 114. In some examples, the mould 111 is the mould 15 described with reference to FIG. 1. The thermoforming mould 120 comprises a pair of thermoforming mould parts 122 that are co-operable with each other along a split plane 123 to define a mould cavity 124. In some examples, the thermoforming mould 120 is the mould 25 described with reference to FIG. 1.

A shape of the mould cavity 114 of the mould 111 differs from a shape of the mould cavity 124 of the thermoforming mould 120, as will be described in more detail herein.

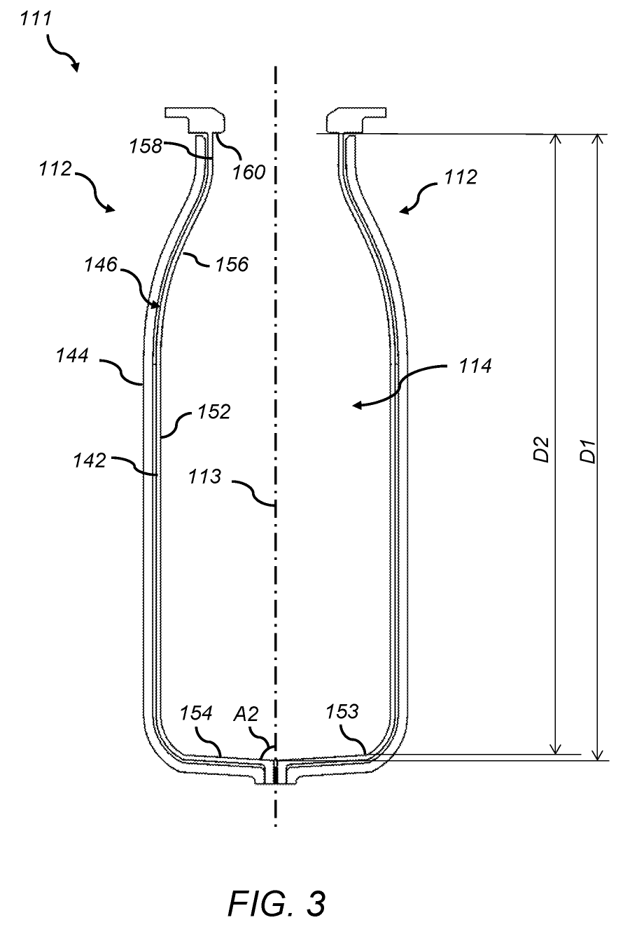

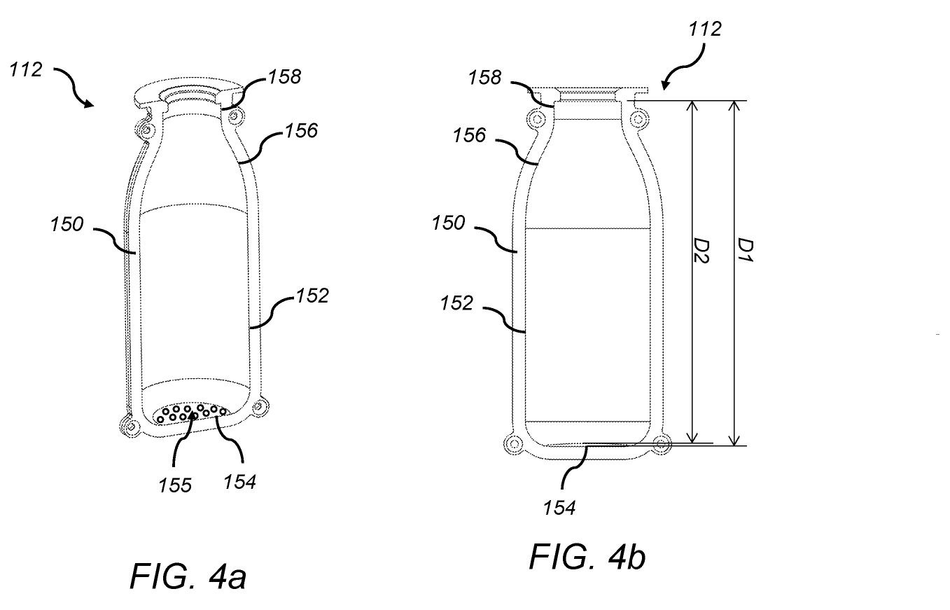

FIG. 3 is a cross-sectional side view of the mould 111, with the mould parts 112 cooperating with one another to define the mould cavity 114. FIGS. 4a and 4b show, respectively, isometric and front views of one of the mould parts 112 of the mould 111. Each mould part 112 has an inner wall 142 that defines the shape of the mould cavity 114, and an outer wall 144 separated from the inner wall 142 by a void 146. In this example, the inner wall 142 and the outer wall 144 have geometries such that the void 146 has a substantially even thickness.

Each mould part 112 has a split face 150 that seals the void 146 at the split plane 113. When the mould parts 112 are cooperating with other another to define the mould cavity 114, as shown in FIG. 3, the split face 150 of one of the mould parts 112 contacts the split face 150 of the other mould part 112. Each mould part 112 is substantially identical in shape to the other. Accordingly, the mould cavity 114 is bisected by the split plane 113.

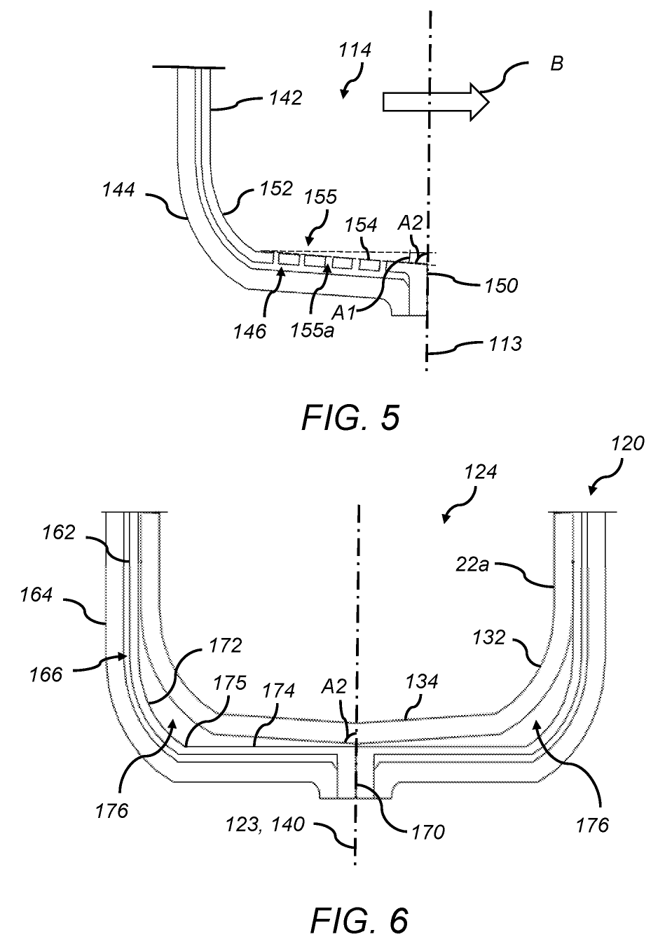

The inner wall 142 of each mould part 112 has a body portion 152, a base portion 154, a shoulder portion 156 and a neck portion 158. The body portion 152, shoulder portion 156 and neck portion 158 collectively define side walls upstanding from the base portion 154. The base portion 154 of each mould part 112 is non-orthogonal to the split plane 113, and is at an acute angle A2 relative to the split plane 113. Accordingly, the base portion 154 of each mould part 112 has a positive draft angle A1, which in this example is around 2.5 degrees, relative to the demoulding direction B of the mould part 112, as shown in FIG. 5, which shows a cross-sectional side view of the base portion 154 and a lower part of the body portion 152 of one of the mould parts 112 of the mould 111. Accordingly, a distance, in a direction parallel to the split plane 113, from an upper edge 160 of the mould part to the base portion 154 is greater along the split plane 113 than towards an edge 153 of the base portion 154 that is most distal from the split plane 113. The base portion 154 is substantially planar such that the draft angle A1 is uniform across the base portion 154 from the edge 153 to the split plane 113.

The body portion 152 is upstanding from the base portion 154, and thus forms walls upstanding from the base portion 154 of each mould part 112. At the split plane 113, the walls extend perpendicularly away from the split plane 113. Along the split plane 113, the mould part 112 has a first height D1. Distal from, but parallel to, the split plane 113, the mould part 112 has a second height D2 smaller than the first height D1.

As shown in FIG. 4a, a number of dewatering apertures 155 extend through the base portion 154 of each mould part 112. The apertures 155 each define a respective conduit 155a that fluidly connects the mould cavity 114 to the void 146 between the inner and outer walls 142, 144 of the mould part 112. This shown more clearly in FIG. 5.

In this example, the conduits extend in a direction that is orthogonal to the surface of the base portion 154 that forms a wall of the mould cavity 114. Due to the positive draft angle of the base portion 154, the conduits are thus obliquely angled relative to the demoulding direction B of the mould part 112. The demoulding direction B is normal to the split plane 113.

Each thermoforming mould part 122 has an inner wall 162 that defines the shape of the mould cavity 114, and an outer wall 164 separated from the inner wall 162 by a void 166. In this example, the inner wall 162 and the outer wall 164 have geometries such that the void 166 has a substantially even thickness. The thermoforming mould parts 122 of the thermoforming mould 120 also each have a split face 170 that contacts the split face 170 of the other mould part 122. The inner wall 162 of each thermoforming mould part 122 also comprise a body portion 172, a base portion 174, a shoulder portion and a neck portion. The body portion 172, shoulder portion 176 and neck portion 178 collectively define side walls upstanding from the base portion 174.

Unlike the mould parts 112 of the mould 111, the base portion 174 of each thermoforming mould part 122 has a draft angle of substantially zero. This is best shown in FIG. 6, which shows a cross-sectional side view of the base portion 174 and a lower part of the body portion 172 of the thermoforming mould parts 122 cooperating together along the mould part 123 to form the mould cavity 124, with a hollow moulded fibre bottle 22a in the mould cavity 124. Accordingly, a distance, in a direction parallel to the split plane 123, from an upper edge of the thermoforming mould part 122 to the base portion 172 is equal when measured along the split plane 123 and when measured from an edge 173 of the base portion 174 that is most distal from the split plane 123.

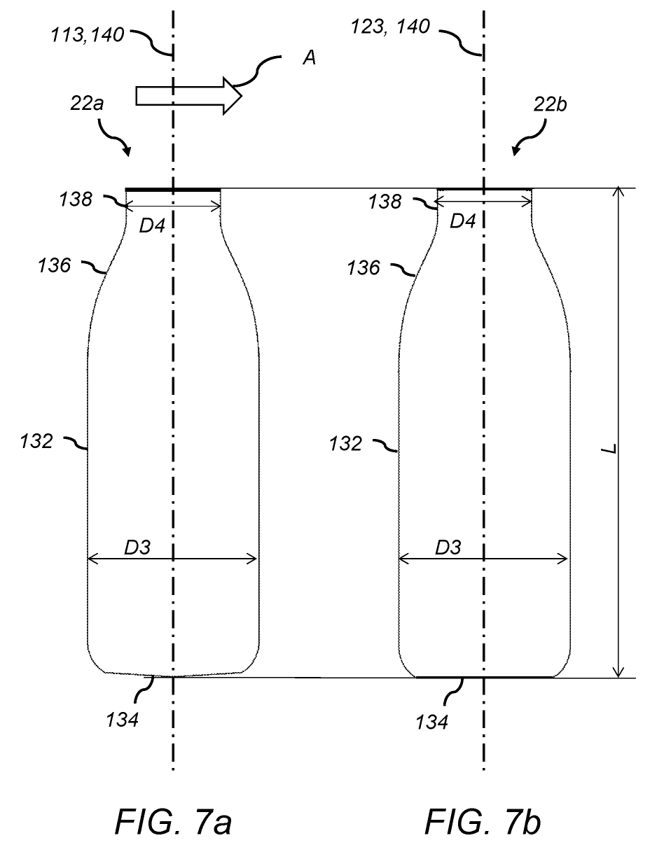

The mould 111 and the thermoforming mould 120 are configured for use in a manufacturing line configured to form a necked-receptable, in this example a bottle. The manufacturing line may be the receptacle manufacturing line described with reference to FIG. 1. The mould 111 is configured to form a hollow moulded fibre bottle 22a, and the thermoforming mould 120 is configured to form a thermoformed hollow moulded fibre bottle 22b, as best shown in FIGS. 7a and 7b and described in more detail hereinafter.

In use of the moulding system 100, with the pair of mould parts 112 of the mould cooperating with each other to define the mould cavity 114, a fibre slurry is supplied to the mould cavity 114 of the mould 111. In use of the mould 111, water (optionally containing additives) from the fibre slurry is drawn from the mould cavity 114 via the apertures 155. The fibre slurry is moulded by the mould 111 to the shape of the mould cavity 114 of the mould 111 to provide the hollow moulded fibre bottle 22a (illustrated in FIG. 7a).

The hollow moulded fibre bottle 22a corresponds in shape to the mould cavity 114 of the mould 111. The hollow moulded fibre bottle 22a is thus generally cylindrical, and has: a body portion 132, a base portion 134 that seals a lower end of the body portion 132, a shoulder portion 136 at an opposite end of the body portion 132 to the base portion 134, and a neck portion 138. The shoulder portion 136 is between the main body portion 132 and the neck portion 138. A length L of the hollow moulded fibre bottle 22a extends along the longitudinal central axis 140 of the hollow moulded fibre bottle 22a. The largest outer diameter D3 of the hollow moulded fibre bottle 22a is found in the body portion 132. The neck portion 138 has a constant outer diameter D4 along its length, which is smaller than the largest outer diameter D3 of the body portion 132. The diameter of the bottle 22a, 22b changes along the shoulder portion 136. When formed in the mould 111, a central longitudinal axis 140 of the bottle 22a lies on the split plane 113.

As a result of the positive draft angle of the base portion 154 of the mould parts 112, the base portion 134 of the hollow moulded fibre bottle 22a is convex. That is, the base portion 134 protrudes from the body portion 132 in a direction along the longitudinal central axis 140 and away from the body portion 132.

Returning to use of the moulding system 100, the mould parts 112 of the mould 111 are separated from one another to permit demoulding of the hollow moulded fibre bottle 22a from the mould 111. The hollow moulded fibre bottle 22a is demoulded from the mould part 112 in a direction that is normal to the split plane 113, as illustrated by arrow A in FIG. 7a.

The transfer mechanism 130 is configured to transfer the hollow moulded fibre bottle 22a from the mould 111 to one of the thermoforming mould parts 122. The thermoforming mould parts 122 are subsequently moved together so that the hollow moulded fibre bottle 22a is in the mould cavity 124 of the thermoforming mould 120. Due to the difference in shape between the mould cavity 114 of the mould 111 and the mould cavity 124 of the thermoforming mould 120, an annular void 176 is formed between an outer surface of the hollow moulded fibre bottle 22a and an inner surface of the inner wall 162 when the transfer mechanism 130 inserts the hollow moulded fibre bottle 22a into the thermoforming mould 120. Such clearance between the outer surface of the hollow moulded fibre bottle 22a and the inner surface of the inner wall 162 can help prevent fibres extending outwardly from the outer surface of the base portion 134 of the hollow moulded fibre bottle 22a from catching on the thermoforming mould part 122 as the hollow moulded fibre bottle 22a is inserted into the thermoforming mould 120.

With the thermoforming mould parts 122 held together with a pressure of around 19.5 bar, a bladder, such as the thermoforming bladder 26 described with reference to FIG. 1, is inserted into the hollow moulded fibre bottle 22a and inflated to a pressure of around 17 bar. The hollow moulded fibre bottle 22a is urged against the inner surface of the inner wall 162 of the thermoforming mould 120 by the bladder to substantially eradicate the annular void 176 between the outer surface of the bottle 22a and the inner surface of the inner wall 162 and thus to form the thermoformed hollow moulded fibre product 22b.

FIG. 7b shows the bottle 22b after being moulded by the thermoforming mould 120, in which the base portion 134 is substantially flat and does not protrude from the body portion 132 in a direction along the central longitudinal axis 140. Since the hollow moulded fibre bottle 22a and the thermoformed hollow moulded fibre bottle 22b are each precursors to a final bottle, and are thus the same bottle at different stages of manufacture, corresponding parts of the bottles 22a, 22b are shown in FIGS. 7a and 7b as having the same reference numbers as each other.

In other examples, at least part of the base portion 174 of each thermoforming mould part 122 has a positive draft angle. For example, each base portion 174 is shaped to form part of a punt in the base portion 134 of the thermoformed hollow moulded fibre bottle 22b. In such examples, a distance, in a direction parallel to the split plane 123, from an upper edge of the thermoforming mould part 122 to the base portion 174 when measured along the split plane 123 is less than the distance when measured from an edge 173 of the base portion 174 that is most distal from the split plane 123.

It will be appreciated that there is provided a control system 102 that is configured to cause a moulding station 110 to supply a fibre slurry to a mould cavity 114 of a mould 111 of the moulding station 110, and mould, using the mould 111, the fibre slurry in the mould cavity 114 to provide a hollow moulded fibre bottle 22a, the hollow moulded fibre bottle 22a having a convex base, as a result of positive draft angles of base portions 154 of first and second mould parts 112 of the mould 111. Also provided is a control system 104 that is configured to cause a moulding system 100 to: cause a moulding station 110 of the moulding system 100 to mould a fibre slurry in a mould cavity 114 defined by mould parts 112 having respective base portions comprising a positive draft angle, to form a hollow moulded fibre bottle 22a; cause a transfer mechanism 130 of the moulding system 100 to transfer the hollow moulded fibre bottle 22a to a mould cavity 124 of a thermoforming mould 120 of the moulding system 100, the mould cavity 124 defined by thermoforming mould parts 122 having respective base portions comprising a smaller draft angle than the mould parts 112; and cause the thermoforming mould 120 to mould the hollow moulded fibre bottle 22a in the mould cavity 124 to provide a thermoformed hollow moulded fibre bottle 22b.

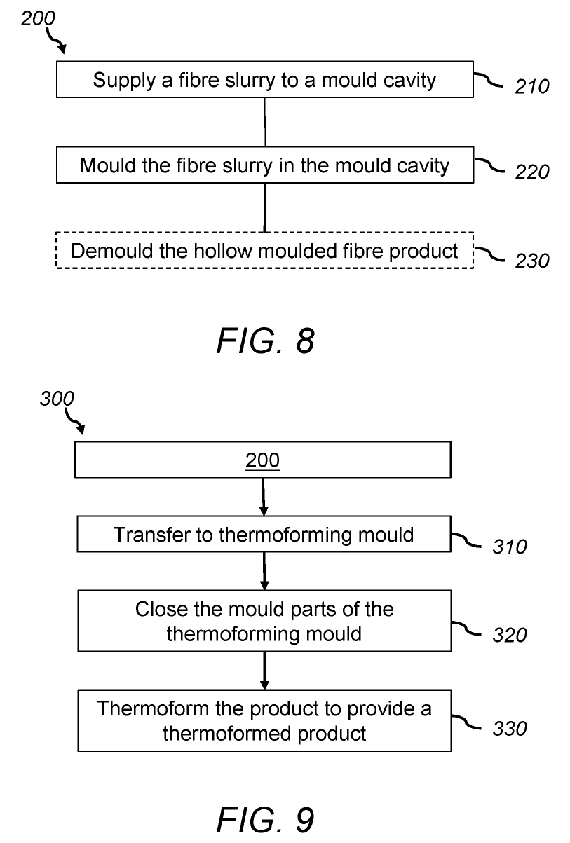

FIG. 8 shows a method 200 of providing a hollow moulded fibre product using a mould comprising a first mould part and a second mould part, the first and second mould parts co-operable with each other, in use of the mould, to together define a mould cavity and each having a base portion with a positive draft angle. The mould may be the mould 111 described above with reference to FIGS. 2-5. The method 200 comprises supplying a fibre slurry to the mould cavity, as denoted by block 210, and moulding, using the mould, the fibre slurry in the mould cavity to provide the hollow moulded fibre product, as denoted by block 220. As a result of the draft angles of the base portions of the first and second mould parts, the resulting hollow moulded fibre product has a convex base. The method 200 further comprises demoulding the hollow moulded fibre product from the mould, as denoted by block 230, although this may be omitted in other examples.

FIG. 9 shows a method 300 of providing a thermoformed hollow moulded fibre product. The method 300 may be known as a fabrication method, in some examples. The method 300 comprises performing the method 200 described above with reference to FIG. 8. The method 300 comprises, after demoulding the hollow moulded fibre product from the mould, subsequently transferring the hollow moulded fibre product to a thermoforming mould, as denoted by block 310. The thermoforming mould comprises a third mould part and a fourth mould part co-operable, in use of the thermoforming mould, to together define a thermoforming cavity, each of the third and fourth mould parts comprise a respective base portion having a draft angle that is less than the positive draft angle of the base portion of the first mould part and the positive draft angle of the base portion of the second mould part. The thermoforming mould may be the thermoforming mould 120 described above with reference to at least FIGS. 2 and 6. The method 300 further comprises closing the third and fourth mould parts when the hollow moulded fibre product is in the thermoforming cavity, as denoted by block 320. In this example, the third and fourth mould parts are held closed with a pressure of around 19.5 bar. The method 300 further comprises thermoforming, using the thermoforming mould, the hollow moulded fibre product in the thermoforming cavity to provide the thermoformed hollow moulded fibre product, as denoted by block 330. The thermoforming urges the hollow moulded fibre product against the walls defining the thermoforming cavity so that the thermoformed hollow moulded fibre product takes the shape of the thermoforming cavity, that being different from the shape of the mould cavity of the mould. Thus, the shape of the thermoformed hollow moulded fibre product differs from the shape of the hollow moulded fibre product.

The method 300 therefore forms a receptacle. For example, FIG. 11 depicts a receptacle 900 that is obtained from the fabrication method.

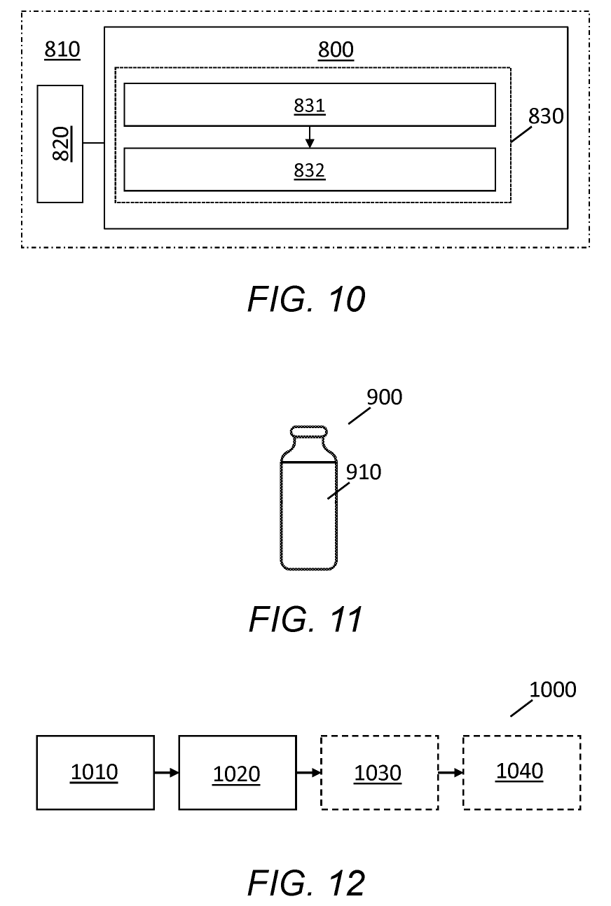

FIG. 10 shows a schematic diagram of a non-transitory computer-readable storage medium 800 according to an example. The non-transitory computer-readable storage medium 800 stores instructions 830 that, if executed by a processor 820 of a control system 810 of a moulding system, cause the moulding system to perform a method according to an example. In some examples, the control system 810 is or comprises the control system 102 of the moulding station 110 as described above. The instructions 830 comprise: causing the moulding station to supply 831 a fibre slurry to a mould cavity of a mould of the moulding station, and mould 832, using the mould, the fibre slurry in the mould cavity to provide a hollow moulded fibre product, the hollow moulded fibre product 22a having a convex base as a result of positive draft angles of base portions of first and second mould parts of the mould. In other examples, the control system 810 is or comprises the control system 104 of the moulding system 100 as described above, and the instructions 830 comprise: causing the moulding station to mould a fibre slurry in a mould cavity defined by mould parts having respective base portions comprising a positive draft angle, to form a hollow moulded fibre product; causing a transfer mechanism to transfer the product to a mould cavity of a thermoforming mould, the mould cavity defined by thermoforming mould parts having respective base portions comprising a smaller draft angle than the mould parts; and causing the thermoforming mould to mould the product in the mould cavity to provide a thermoformed hollow moulded fibre product. In other examples, the instructions 830 comprise instructions to perform any other example methods described herein.

It will also be appreciated that there also is provided a receptacle manufacturing line (such as that shown in FIG. 1) comprising a moulding system for providing a thermoformed hollow moulded fibre product and apparatus for performing at least one additional process on the thermoformed hollow moulded fibre product to provide the receptacle. Similarly, also provided is a method of manufacturing a receptacle, the method comprising: moulding a fibre slurry in a mould cavity defined by mould parts having respective base portions comprising a positive draft angle, to form a hollow moulded fibre product; causing a transfer mechanism to transfer the product to a mould cavity of a thermoforming mould, the mould cavity defined by thermoforming mould parts having respective base portions comprising a smaller draft angle than the mould parts; and causing the thermoforming mould to mould the product in the mould cavity to provide a thermoformed hollow moulded fibre product, and then performing at least one additional process on the thermoformed hollow moulded fibre product to provide the receptacle. Examples of the “at least one additional process” are described above with reference to FIG. 1.

Also provided, as a result of the content of the present application, is use of a receptacle obtained by any of the methods described herein to contain contents. An example such receptacle 900, in the form of a necked receptacle and specifically a bottle, containing contents 910 is shown in FIG. 11. The use could be, for example, by a person who puts the contents into the receptacle, by a person who transports the contents, or by a person who wishes to dispose of (for example, to a consumer or end user), offer to dispose of (for example, to a consumer or end user), import, or keep the contents whether for disposal or otherwise. The contents could, for example, be any one or more of the example contents described herein.

Also provided is a method of providing a content-containing receptacle. An example such method 1000 is shown in FIG. 12. The method 1000 comprises providing 1010 the receptacle, in the form of a necked receptacle and specifically a bottle, and then providing 1020 the contents in the receptacle. In this example, block 1020 follows block 1010, so that block 1020 comprises putting the contents into the receptacle that has been provided at block 1010. However, in some other examples, blocks 1010 and 1020 are performed concurrently, so that the providing 1010 the receptacle comprises providing the receptacle with the contents already present in the receptacle. The contents could, for example, be any one or more of the example contents described herein. The method 1000 also comprises closing 1030 an opening of the receptacle after block 1020, and applying 1040 a label or indicia to the receptacle after block 1030. In this example, block 1030 involves applying a heat seal to the opening and then screwing a cap or lid onto the receptacle, and block 1040 comprises adhering a label onto the receptacle.

In respective other examples, the order of blocks 1030 and 1040 is reversed, blocks 1030 and 1040 are performed concurrently, block 1030 is omitted, and block 1040 is omitted. In some examples, block 1040 occurs before block 1020, or block 1040 occurs during block 1020. For example, in some cases, the label or indicia is applied to the receptacle, then the contents are provided in the receptacle, and then the receptacle is closed.

It will be appreciated that the method 1000 could be performed by the same party that manufactures the receptacle, for example so that block 1010 comprises the method discussed above with reference to the manufacturing line shown in FIG. 1. Alternatively, the method 1000 could be performed by a different party to that which manufactures the receptacle. In such an alternative, the different party performs block 1010 by way of obtaining the receptacle from the party that manufactures the receptacle (such as by way of the method discussed above with reference to FIG. 1) or from an intermediary.

Example embodiments of the present invention have been discussed, with reference to the examples illustrated. However, it will be appreciated that variations and modifications may be made without departing from the scope of the invention as defined by the appended claims.

What is claimed is:

1. A mould part for use in moulding a hollow moulded fibre product, the mould part being co-operable in use with a further mould part to together define a cavity in which the hollow moulded fibre product is moulded, the mould part having a base portion corresponding to a part of a base of the hollow moulded fibre product to be moulded by the mould part in use, wherein the base portion has a positive draft angle.

2. The mould part of claim 1, wherein the positive draft angle does not exceed 5 degrees.

3. The mould part of claim 1, wherein the positive draft angle is uniform across the base portion.

4. The mould part of claim 1, wherein the base portion comprises one or more dewatering apertures extending therethrough.

5. The mould part of claim 4, wherein each of the one or more dewatering apertures defines a respective conduit fluidly connecting an internal moulding cavity defined by the mould part to an outside of the mould part, the conduits being obliquely angled relative to a demoulding direction of the mould part.

6. The mould part of claim 1, comprising one or more side walls upstanding from the base portion, wherein a height of the one or more side walls at a split plane of the mould part is greater than a height of the one or more side walls at a rear of the mould part, opposite the split plane.

7. The mould part of claim 6, wherein, at the split plane, the side walls extend perpendicularly away from the split plane.

8. A moulding station for use in moulding a hollow moulded fibre product, the moulding station comprising a mould having a first mould part and a second mould part, each of the first and second mould parts being according to claim 1,
wherein the first and second mould parts are co-operable with each other, in use of the mould, to together define a mould cavity, in which the hollow moulded fibre product is moulded.

9. The moulding station of claim 8, wherein the base portion of the first mould part and the base portion of the second mould part have the same positive draft angle.

10. A moulding system for providing a thermoformed hollow moulded fibre product, the moulding system comprising:
the moulding station of claim 8; and
a thermoforming mould;
wherein the thermoforming mould comprises a third mould part and a fourth mould part co-operable, in use of the thermoforming mould, to together define a thermoforming cavity in which the hollow moulded fibre product is moulded to form the thermoformed hollow moulded fibre product, each of the third and fourth mould parts comprising a respective base portion having a draft angle that is less than the positive draft angle of the base portion of the first mould part and the base portion of the second mould part.

11. The moulding system of claim 10, wherein the third and fourth mould parts are configured to be held together with a pressure of at least 15 bar.

12. A method of providing a hollow moulded fibre product using a mould comprising a first mould part and a second mould part, the first and second mould parts being co-operable with each other, in use of the mould, to together define a mould cavity and each having a base portion with a positive draft angle, the method comprising:
supplying a fibre slurry to the mould cavity; and
moulding, using the mould, the fibre slurry in the mould cavity to provide the hollow moulded fibre product, the hollow moulded fibre product having a convex base as a result of the draft angles of the base portions of the first and second mould parts.

13. The method of claim 12, wherein the method comprises demoulding the hollow moulded fibre product from the mould.

14. A method of providing a thermoformed hollow moulded fibre product, the method comprising:
performing the method of claim 13;
subsequently transferring the hollow moulded fibre product to a thermoforming mould, the thermoforming mould comprising a third mould part and a fourth mould part co-operable, in use of the thermoforming mould, to together define a thermoforming cavity, each of the third and fourth mould parts comprising a respective base portion having a draft angle that is less than the positive draft angle of the base portion of the first mould part and the positive draft angle of the base portion of the second mould part;
closing the third and fourth mould parts when the hollow moulded fibre product is in the thermoforming cavity; and
thermoforming, using the thermoforming mould, the hollow moulded fibre product in the thermoforming cavity to provide the thermoformed hollow moulded fibre product.

15. A moulding system controller configured to cause a moulding station for use in moulding a hollow moulded fibre product to perform the method of claim 12.

16. A non-transitory storage medium storing machine-readable instructions that, when executed by a processor of a moulding system controller, cause the processor to cause a moulding station to perform the method of claim 12.

17. A receptacle manufacturing line comprising the moulding system of claim 10 for providing the thermoformed hollow moulded fibre product and apparatus for performing at least one additional process on the thermoformed hollow moulded fibre product to provide the receptacle.

18. A receptacle produced by the process comprising:
(i) providing a hollow moulded fibre product using a mould comprising a first mould part and a second mould part, the first and second mould parts being co-operable with each other, in use of the mould, to together define a mould cavity and each having a base portion with a positive draft angle;
(ii) supplying a fibre slurry to the mould cavity;
(iii) moulding, using the mould, the fibre slurry in the mould cavity to provide the hollow moulded fibre product, the hollow moulded fibre product having a convex base as a result of the draft angles of the base portions of the first and second mould parts;
(iv) demoulding the hollow moulded fibre product from the mould; and
subsequent to (i)-(iv), transferring the hollow moulded fibre product to a thermoforming mould, the thermoforming mould comprising a third mould part and a fourth mould part co-operable, in use of the thermoforming mould, to together define a thermoforming cavity, each of the third and fourth mould parts comprising a respective base portion having a draft angle that is less than the positive draft angle of the base portion of the first mould part and the positive draft angle of the base portion of the second mould part;
closing the third and fourth mould parts when the hollow moulded fibre product is in the thermoforming cavity; and
thermoforming, using the thermoforming mould, the hollow moulded fibre product in the thermoforming cavity to provide the thermoformed hollow moulded fibre product.
